(19) United States
(12) Patent Application Publication
(10) Pub. No.: US 2009/0051693 A1
(43) Pub. Date: Feb. 26, 2009

(54) DISPLAY CONTROL METHOD USED IN A DISPLAY APPARATUS , AND DISPLAY APPARATUS

(75) Inventors: Hirokazu ROKUSHIMA, Kato (JP); Makoto FUKATA, Kato (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/129,878

(22) Filed: May 30, 2008

(30) Foreign Application Priority Data
Aug. 20, 2007 (JP) 2007-214168

(51) Int. Cl. G06F 13/14

(52) U.S. Cl. 345/520

(57) ABSTRACT

The display control method includes the steps of: making a first determination of whether the analog RGB signal is present or absent, and switching an input to the analog RGB signal and displaying an image expressed by the analog RGB signal when the analog RGB signal has been determined to be present; making a second determination of whether the digital signal is present or absent when the analog RGB signal has been determined to be absent, and switching the input to the digital signal and displaying an image expressed by the digital signal when the digital signal has been determined to be present; and starting a power-saving mode after a predetermined lapse of time when both the analog RGB signal and the digital signal have been determined to be absent.

### BACKGROUND OF THE INVENTION

1. Field of the Invention

The present invention relates to a display control method used in a display apparatus provided with an analog interface for inputting an analog RGB signal and a digital interface for inputting a digital signal based on the DVI standard, and to a display apparatus.

2. Description of the Related Art

Various types of display apparatuses, such as CRT displays, liquid-crystal displays, and plasma displays, have conventionally been used to display image signals (video signals) outputted from computers, video devices, and the like.

Many such display apparatuses that are currently being used are provided with both an analog interface for inputting an analog RGB signal and a digital interface for inputting a digital signal based on the DVI (Digital Visual Interface) standard.

An analog RGB terminal is a representative example of such an analog interface. An analog RGB terminal transmits both an analog signal for each of R, G, and B color components (i.e., a video signal) and a control signal. Meanwhile, a DVI-D terminal is a representative example of a digital interface. A DVI-D terminal transmits both a digital signal for each of R, G, and B color components (i.e., a video signal) and a control signal.

With a display apparatus that includes both of these interfaces, it is normally necessary to switch between the interfaces in accordance with the type of signal inputted into the display apparatus. For example, it is necessary to switch over to the digital signal when an image signal is inputted into the display apparatus from a computer via the digital interface, whereas it is necessary to switch over to the analog RGB signal when the image signal is inputted into the display apparatus from the computer via the analog interface. Switching the interface is typically carried out by an SE (system engineer) during the initial settings s/he performs when setting up the computer system. However, there are also cases where the user him/herself both performs the initial settings and switches the interface.

JP 2002-169532A discloses an apparatus provided with a connector detection unit. This connector detection unit detects whether a connector is a DVI-D type connector or a DVI-I type connector. The apparatus switches video signals and synchronization signals based upon the results of this detection. The connector detection unit determines that an analog interface has been connected when the C5 pin in the DVI-I type connector is grounded.

In the case where the user switches the interface, the switching operation is carried out using a remote-control device or operation keys belonging to the computer or the like. However, there are situations where an inexperienced user cannot perform the switching operation properly, resulting in nothing being displayed in the display apparatus even when the system is turned on. Such a situation inconveniences the user, who then must rely on a system engineer for assistance.

Meanwhile, according to the apparatus disclosed in JP 2002-169532A, the apparatus switches to the analog signal when the C5 pin in the DVI-I type connector is grounded. However, there is no guarantee that the analog RGB signal is being outputted even when a connector and cable are connected to the DVI-I type connector, and thus there are situations in which the switch cannot be carried out with accuracy. For example, in the case where a cable is connected to both a DVI-D type connector and a DVI-I type connector but only a digital signal is being outputted, the connector detection unit determines that the signal is analog and switches accordingly. The result is that no video is displayed in the display surface.

Furthermore, the apparatus disclosed in JP 2002-169532A assumes, as a prerequisite, that a DVI-I type connector is used as the analog interface. Therefore, the apparatus disclosed in JP 2002-169532A cannot be applied when using, for example, a 15-pin analog RGB terminal.

### SUMMARY

The present invention has been conceived in light of the aforementioned problems, and it is an object thereof to provide a display control method and a display apparatus that can accurately determine and switch between analog and digital signals, even in the case where a DVI-I type connector is not used as an analog interface for analog RGB signals.

A control method according to one aspect of the present invention is a display control method used in a display apparatus provided with an analog interface for inputting an analog RGB signal and a digital interface for inputting a digital signal based on the DVI standard, the display apparatus being configured to switch to either the analog RGB signal inputted via the analog interface or the digital signal inputted via the digital interface and display, in a display surface, an image expressed either by the analog RGB signal or by the digital signal. The method includes the steps of making a first determination of whether the analog RGB signal is present or absent, and switching an input to the analog RGB signal and displaying an image expressed by the analog RGB signal when the analog RGB signal has been determined to be present, making a second determination of whether the digital signal is present or absent when the analog RGB signal has been determined to be absent, and switching the input to the digital signal and displaying an image expressed by the digital signal when the digital signal has been determined to be present, and starting a power-saving mode after a predetermined lapse of time when both the analog RGB signal and the digital signal have been determined to be absent.

According to this aspect of the invention, the determination of whether a signal is an analog RGB signal or a digital signal can be carried out accurately, and the proper signal can be switched to automatically. Note that the digital signal may be a DVI-D signal.

Preferably, the first determination and the second determination may be carried out only when the display apparatus is initially turned on for use, and a state of switching performed in accordance with the first determination and the second determination may be stored in a memory, and the input may be switched to match the state stored in the memory and an image is displayed the second and subsequent times the display apparatus is turned on.

According to this aspect of the invention, the determination of whether a signal is an analog RGB signal or a digital signal can be carried out with a minimal amount of processing.

According to the structure described above, it is possible to accurately determine and switch between analog and digital signals, even in the case where a DVI-I type connector is not used as an analog interface for analog RGB signals.

### BRIEF DESCRIPTION OF THE DRAWINGS

FIG. 1 is a diagram illustrating an example of the configuration of a computer system according to an embodiment of the present invention.

FIG. 2 is a block diagram illustrating an example of the functional configuration of a display apparatus.

FIG. 3 is a block diagram illustrating an example of the functional configuration of a control unit of a display apparatus.

FIG. 4 is a diagram illustrating the details of operations performed by a synchronization detection unit.

FIG. 5 is a diagram illustrating an example of the configuration of a DDC detection unit.

FIG. 6 is a flowchart illustrating an example of a display control procedure performed by a display apparatus.

FIG. 7 is a flowchart illustrating another example of processing carried out prior to entering a power-saving mode.

### DESCRIPTION OF THE PREFERRED EMBODIMENTS

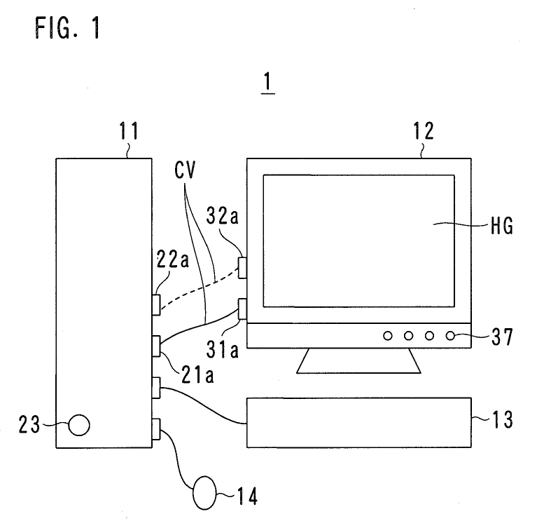

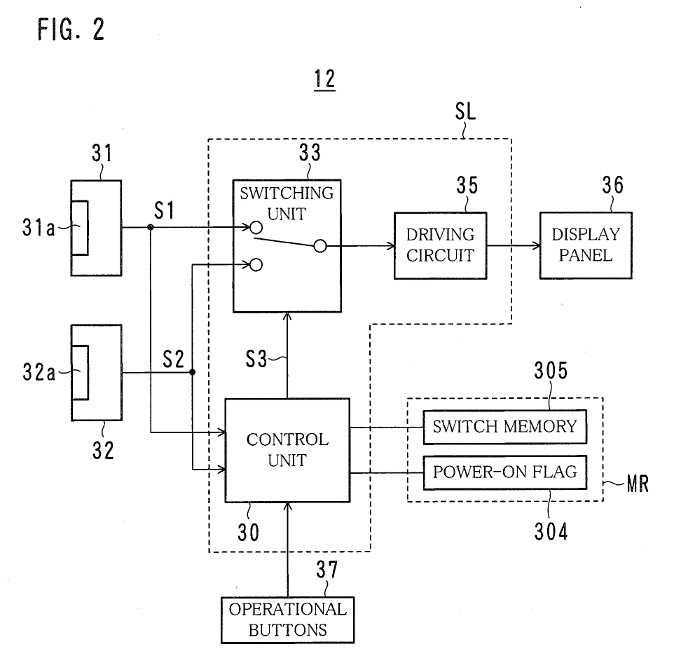

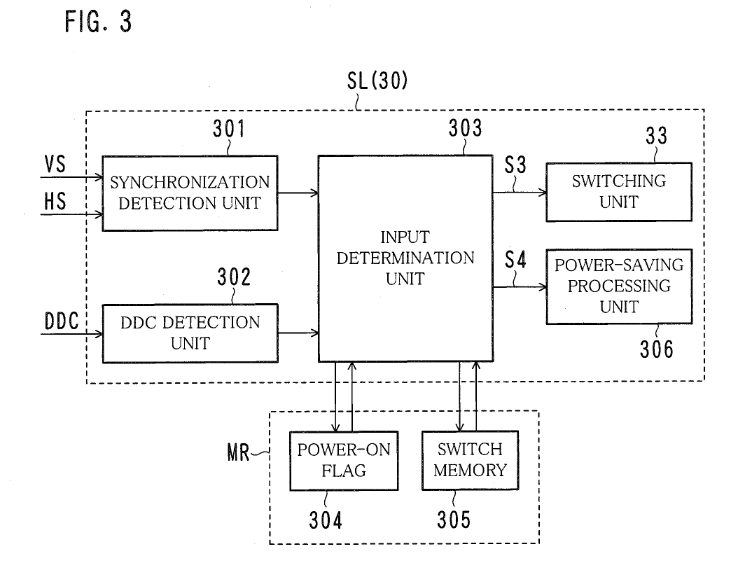

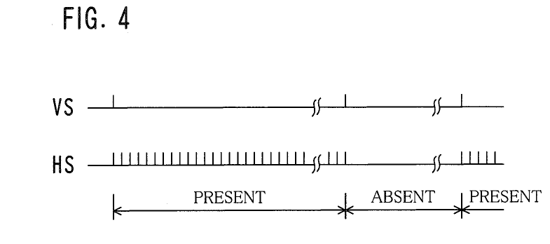

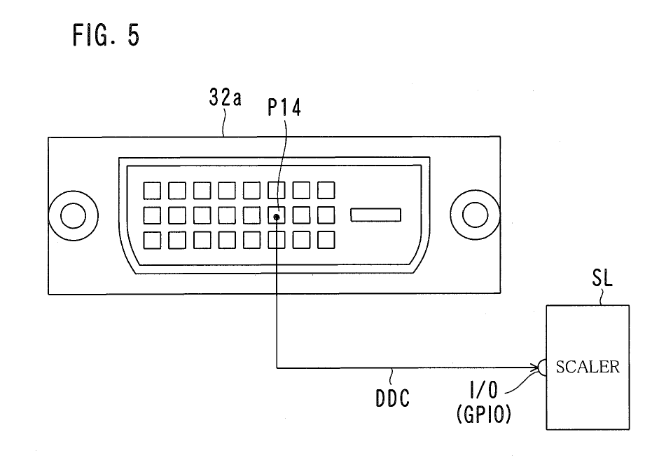

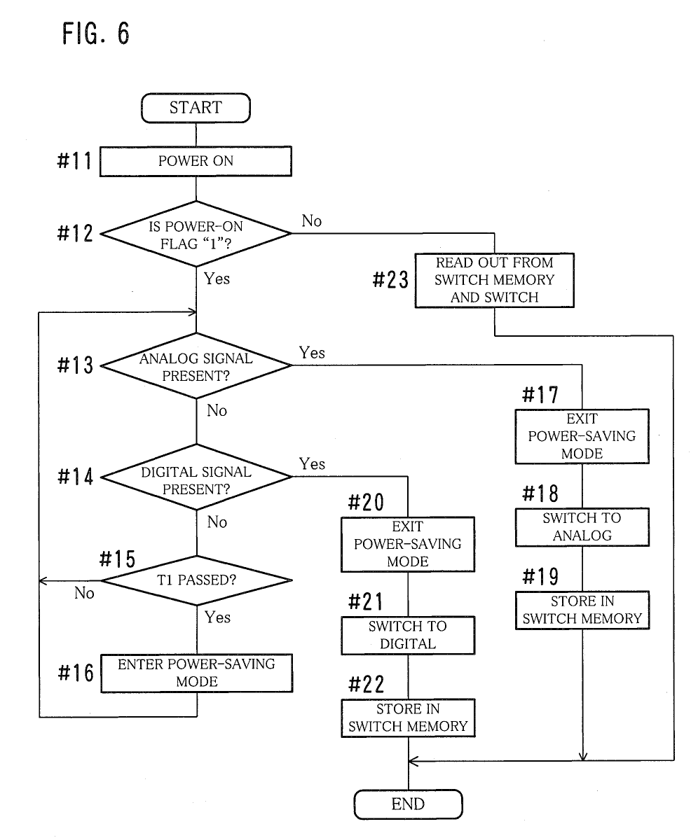

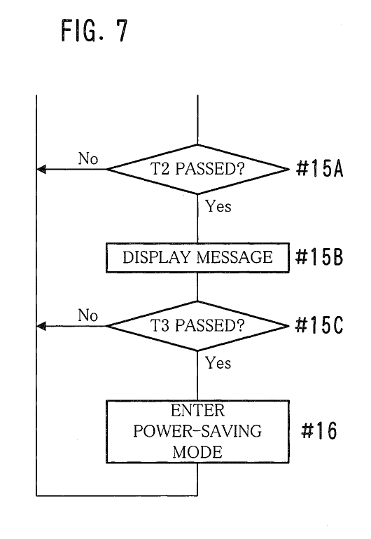

FIG. 1 is a diagram illustrating the configuration of a computer system 1 according to an embodiment of the present invention; FIG. 2 is a block diagram illustrating an example of the functional configuration of a display apparatus 12; FIG. 3 is a block diagram illustrating an example of the functional configuration of a scaler SL (control unit 30) of the display apparatus 12; FIG. 4 is a diagram illustrating the details of operations performed by a synchronization detection unit; FIG. 5 is a diagram illustrating an example of the configuration of a DDC detection unit; FIG. 6 is a flowchart illustrating an example of a display control procedure performed by the display apparatus 12; and FIG. 7 is a flowchart illustrating another example of processing carried out prior to entering a power-saving mode.

The computer system 1 illustrated in FIG. 1 is configured of a main computer portion 11, the display apparatus 12, a keyboard 13, and a mouse 14. A CPU board (motherboard), memory board, graphics board, sound board, interface board, and other boards, as well as a power source, are included within the main computer portion 11. A hard disk drive, disk drive such as a CD-ROM drive, a DVD-ROM drive, or the like, and other media drives are also included in the main computer portion 11. The main computer portion 11 is further provided with various interfaces that include connectors for connecting the display apparatus 12, the keyboard 13, and the mouse 14, and is also provided with a network interface for connecting to a LAN, the Internet, or the like.

In the present embodiment, the main computer portion 11 further includes a D-sub 15-pin analog RGB terminal 21a and a DVI-D terminal 22a for connecting the display apparatus 12. The main computer portion 11 is also provided with a power switch 23.

The display apparatus 12 uses a liquid-crystal display (liquid-crystal panel) as its display surface. The display apparatus 12 includes an analog interface 31 for inputting an analog RGB signal and a digital interface 32 for inputting a digital signal based on the DVI standard. In the present embodiment, the display apparatus 12 is provided with a 15-pin analog RGB terminal 31a as a connector for the analog interface and a DVI-D terminal 32a as a connector for the digital interface.

The video signal output terminals of the main computer portion 11 or another device can be connected to the analog RGB terminal 31a and the DVI-D terminal 32a by using the appropriate cables CV.

The analog RGB terminal 31a transmits signals that represent the darkness (tone) of R (red), G (green), and B (blue) colors as voltages of different sizes. In addition to this, the analog RGB terminal 31a also transmits vertical synchronization signals and horizontal synchronization signals.

The DVI-D terminal (DVI-D connector) 32a is, along with the DVI-I terminal, DVI-A terminal, and so on, a standard specification proposed by the DDWG (Digital Display Working Group) as an interface for video output. The technological basis of the DVI standard utilizes a serial format called TMDS (Transition Minimized Differential Signaling). DVI-D terminals are used only for digital signals, whereas DVI-I terminals can be used for both digital and analog signals. DVI-A terminals, on the other hand, are used only for analog signals. The DVI standard has single link mode and dual link mode.

The display apparatus 12 switches to one of the analog RGB signal inputted via the analog interface 31 and the digital signal inputted via the digital interface 32, and displays the image thereof in a display surface HG.

The display apparatus 12 is also provided with plural operational buttons 37, for performing various settings, adjustments, and so on.

As illustrated in FIG. 2, the display apparatus 12 is configured of the control unit 30, the analog interface 31, the digital interface 32, a switching unit 33, a driving circuit 35, a display panel 36, the operational buttons 37, and a memory MR.

The control unit 30 outputs a control signal S3, for switching between an analog RGB signal S1 and a digital signal S2, to the switching unit 33, thereby performing display control; the control unit 30 also controls the display apparatus 12 as a whole. A vertical synchronization signal VS and horizontal synchronization signal HS are inputted into the control unit 30 from the analog interface 31, and whether the analog RGB signal S1 is present or absent is determined based on the input thereof. Furthermore, the 14 pin (DDC terminal) DDC signal of the DVI-D terminal 32a is inputted into the control unit 30 from the digital interface 32, and whether the digital signal S2 is present or absent is determined based on this input.

The control unit 30 is connected to a power-on flag 304 and a switch memory 305 provided in the memory MR, and reads out the details stored therein, or writes data therein. The memory MR is configured of a rewritable memory, such as a flash memory, EEPROM, or the like, where data stored therewithin is not deleted when the power is turned off.

The power-on flag 304 is set at “1” when the display apparatus 12 is originally shipped from the factory as a product; however, the flag is reset to “0” when the user first turns the display apparatus 12 on. Accordingly, it is recognized whether or not the display apparatus 12 has been turned on for use for the first time. The switch memory 305 stores the details of the control signal S3 outputted to the switching unit 33 by the control unit 30. Display control is carried out in accordance with the details stored in the switch memory 305 when the display apparatus 12 is turned on for the second or a subsequent time. Operations of the control unit 30 shall be described in detail later.

The analog interface 31 and digital interface 32 are, as mentioned above, interfaces for inputting the analog RGB signal S1 and the digital signal S2 serving as the DVI signal, respectively. These interfaces include the analog RGB terminal 31a and DVI-D terminal 32a, respectively, which themselves are publicly-known circuits.

Under control of the control unit 30, the switching unit 33 switches to one of the analog RGB signal S1 inputted via the analog interface 31 and the digital signal S2 inputted via the digital interface 32. Note that the switching unit 33 switches the video signal and the synchronization signals simultaneously.

The driving circuit 35 drives the display panel 36 based on the signal outputted from the switching unit 33. In other words, the driving circuit 35 drives the display panel 36 so as to display video based on the signal selected from among the analog RGB signal S1 and the digital signal S2.

The operational buttons 37 are used to adjust the image and sound of the display apparatus 12, set the operational mode of the display apparatus 12, and so on. For example, the operational buttons 37 are used when manually switching between the analog RGB signal S1 and the digital signal S2. An operational switch for turning the power of the display apparatus 12 on/off may be included in the operational buttons 37. However, the power can be turned on/off under control of the main computer portion 11; alternatively, power to the display apparatus 12 may be supplied by the main computer portion Note that the functions of the control unit 30, the switching unit 33, and the driving circuit 35 can be implemented by the scaler SL, configured of a single IC (Integrated Circuit). In general, the scaler SL checks the inputted signal (video signal) and converts the resolution, format, and so on of the signal. A plurality of GPIO (General Purpose Input/Output) terminals is provided in the scaler SL, and the statuses of signals inputted into these terminals can be determined and a signal outputted. For example, by connecting the 14 pin of the DVI-D terminal 32a to one of the GPIO terminals in the scaler SL as illustrated in FIG. 5, it can be determined whether or not a voltage of 5V is being applied to the 14 pin; the scaler SL can then obtain an output based on the results of the determination. Note that the actual processing operations performed by the GPIO terminal in the scaler SL are publicly-known.

The scaler SL (control unit 30) illustrated in FIG. 3 includes a synchronization detection unit 301, a DDC detection unit 302, an input determination unit 303, and a power-saving processing unit 306. The power-on flag 304 and switch memory 305 are provided in the memory MR.

The synchronization detection unit 301 determines whether the analog RGB signal S1 is present or absent based on the vertical synchronization signal VS and horizontal synchronization signal HS inputted from the analog interface 31. For example, the synchronization detection unit 301 detects whether the vertical synchronization signal VS and the horizontal synchronization signal HS are present or absent and outputs a signal indicating the presence of the analog RGB signal S1 when both of the synchronization signals are present, as illustrated in FIG. 4.

The DDC detection unit 302 determines whether the digital signal S2 is present or absent based on the plus 5V DDC signal inputted through the 14 pin of the DVI-D terminal 32a. For example, the DDC detection unit 302 outputs a signal indicating that the digital signal S2 is present in the case where the voltage in the line connected to the 14 pin of the DVI-D terminal 32a is greater than a threshold.

When the synchronization detection unit 301 has determined that the analog RGB signal S1 is present, the input determination unit 303 outputs a control signal S3 for switching the switching unit 33 to the analog RGB signal S1. Meanwhile, when the DDC detection unit 302 has determined that the digital signal S2 is present, the input determination unit 303 outputs a control signal S3 for switching the switching unit 33 to the digital signal S2. Based on the control signal S3, the switching unit 33 switches to one of the analog RGB signal S1 and the digital signal S2.

When the control signal S3 has been outputted, the details in the switch memory 305 are rewritten based on the details of the control signal S3. In addition, when the control signal S3 has been outputted after the apparatus has been turned on by the user for the first time and the details of the power-on flag 304 have been read out, the power-on flag 304 is reset to “0”.

Furthermore, a power-saving signal S4, for entering a power-saving mode, is outputted to the power-saving processing unit 306 in the case where neither the analog RGB signal S1 nor the digital signal S2 are present for a predetermined amount of time.

Upon the input of the power-saving signal S4, the power-saving processing unit 306 stops the supply of power to pre-set processing blocks in the circuits within the display apparatus 12. Accordingly, when the apparatus has entered the power-saving mode, there are both processing blocks to which the supply of power has been stopped and which do not carry out processing, and processing blocks to which the supply of power continues and which continue their processing.

It should be noted here that FIGS. 2, 3, and 5 and the descriptions thereof illustrate an exemplary configuration for implementing functions within the display apparatus 12, and that the functions can also be implemented by selecting only certain elements or combining elements illustrated therein.

For example, when the 14 pin of the DVI-D terminal 32a has been connected to a GPIO terminal in the IC (Integrated Circuit) serving as the scaler SL, as shown in FIG. 5, the DDC detection unit 302 and the input determination unit 303 shown in FIG. 3 carry out processing based on the DDC signal inputted from the GPIO terminal.

In FIG. 6, when the display apparatus 12 is turned on for the first time (#11), it is determined whether or not the power-on flag 304 is “1” (#12). If the flag is “1”, it is checked whether the analog RGB signal S1 is present or absent, so that initial settings for display control can be performed (#13). If the analog RGB signal S1 is present, the power-saving mode is exited as necessary (#17), the analog RGB signal S1 is switched to (#18), and the details of the switch are stored in the switch memory 305 (#19).

If, however, the analog RGB signal S1 is absent, it is checked whether the digital signal S2 is present or absent (#14). If the digital signal S2 is present, the power-saving mode is exited as necessary (#20), the digital signal S2 is switched to (#21), and the details of the switch are stored in the switch memory 305 (#22). Note that the power-on flag 304 is reset to “0” in step #19 or #22, when the switch details are stored in the switch memory 305.

If neither the analog RGB signal S1 nor the digital signal S2 is present, and a set amount of time T1 has passed (YES in #15), the power-saving signal S4 is outputted, thereby putting the apparatus into the power-saving mode (#16). Note that this means that during the time T1, the determination as to whether the analog RGB signal S1 and the digital signal S2 are present or absent is repeated, and, only when neither the analog RGB signal S1 nor the digital signal S2 is present during this interval, the apparatus enters the power-saving mode once the time T1 has passed after it has first been determined that neither the analog RGB signal S1 nor the digital signal S2 is present.

If the power-on flag 304 is “0”, the initial display control has already been carried out. Therefore, the details of the switch memory 305 are read out, and either the analog RGB signal S1 or the digital signal S2 is switched to based upon those details (#23).

In FIG. 7, if neither the analog RGB signal S1 nor the digital signal S2 is present, and a set amount of time T2 has passed (YES in #15A), a message indicating that no video signal is being inputted is first displayed in the display surface HG (#15B). Then, once a set amount of time T3 has passed (YES in #15C), the apparatus is put into the power-saving mode (#16). The times T2 and T3 may be set to, for example, approximately 10 seconds and approximately 30 seconds, respectively.

In this manner, in the present embodiment, when the display apparatus 12 is turned on for the first time, it is first checked whether the analog RGB signal S1 is present or absent. At substantially the same time, it is also checked whether the digital signal S2 is present or absent. The type of the video signal being inputted into the display apparatus 12 is automatically and accurately determined based on the results, and the signals are switched to as appropriate.

According to the present embodiment, the actual signal or voltage appearing in a video signal inputted to the display apparatus 12 from the exterior (e.g. the main computer portion 11) is monitored and the presence or absence thereof is determined, meaning that an accurate determination can be performed. Furthermore, the determination can be carried out with accuracy even if the formats or types of connectors differ.

Furthermore, according to the present embodiment, the determination is carried out through monitoring the synchronization signals of the analog RGB signal S1 and the DDC signal of the digital signal S2; thus, even if the apparatus itself has entered the power-saving mode, this determination can be executed by a processing block that has not entered the power-saving mode, making it possible to improve the power-saving effectiveness of the apparatus. There is also a high level of freedom with which settings can be made for assigning which processing blocks enter the power-saving mode and which processing blocks do not enter the power-saving mode when the apparatus itself enters the power-saving mode.

The procedures illustrated in the flowcharts of FIGS. 6 and 7 and described in the abovementioned embodiment can be carried out by a single CPU executing a program. In such a case, these procedures are carried out within a series of processes executed by the CPU, and furthermore, the CPU executes processes at high speed; accordingly, the processes indicated by steps #13 and #14, or in other words, the determination of whether the analog RGB signal S1 is present or absent and the determination of whether the digital signal S2 is present or absent, are executed at substantially the same time.

Accordingly, the display control for the display apparatus 12 can be realized via hardware, utilizing various semiconductor devices; via software, through the CPU executing a program; or by a combination of the two.

In the embodiment described above, other terminals (connectors) or interfaces can be used as the DVI interface, instead of the DVI-D terminal. Although in the example given above, the video signal output terminal of the main computer portion 11 is connected to the analog RGB terminal 31a or the DVI-D terminal 32a of the display apparatus 12 using the cable CV, a different device may be connected, instead of connecting the main computer portion 11.

The configuration, structure, shape, dimensions, number, and processing content/order of the display apparatus 12, the computer system 1, and the elements contained therewithin, can be altered as appropriate without departing from the spirit of the present invention.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A display control method used in a display apparatus provided with an analog interface for inputting an analog RGB signal and a digital interface for inputting a digital signal based on the DVI standard, the display apparatus being configured to switch to either the analog RGB signal inputted via the analog interface or the digital signal inputted via the digital interface and display, in a display surface, an image expressed either by the analog RGB signal or by the digital signal, the method comprising the steps of:
making a first determination of whether the analog RGB signal is present or absent, and switching an input to the analog RGB signal and displaying an image expressed by the analog RGB signal when the analog RGB signal has been determined to be present;
making a second determination of whether the digital signal is present or absent when the analog RGB signal has been determined to be absent, and switching the input to the digital signal and displaying an image expressed by the digital signal when the digital signal has been determined to be present; and
starting a power-saving mode after a predetermined lapse of time when both the analog RGB signal and the digital signal have been determined to be absent.

2. The display control method according to claim 1,
wherein the digital signal is a DVI-D signal.

3. The display control method according to claim 2,
wherein the first determination and the second determination are carried out only when the display apparatus is initially turned on for use, and
a state of switching performed in accordance with the first determination and the second determination is stored in a memory, and the input is switched to match the state stored in the memory and an image is displayed the second and subsequent times the display apparatus is turned on.

4. The display control method according to claim 3,
wherein in the second determination, the digital signal is determined to be present when a predetermined voltage is being applied to a DDC terminal, and the digital signal is determined to be absent when the predetermined voltage is not being applied to the DDC terminal.

5. The display control method according to claim 4,
wherein in the first determination, the analog RGB signal is determined to be present when both a horizontal synchronization signal and a vertical synchronization signal are being outputted.

6. The display control method according to claim 4,
wherein the first determination and the second determination are carried out at substantially the same time, by being carried out within a series of processes executed by a CPU.

7. A display apparatus provided with an analog interface for inputting an analog RGB signal and a digital interface for inputting a digital signal based on the DVI standard, the display apparatus being configured to switch, using a switch, to either the analog RGB signal inputted via the analog interface or the digital signal inputted via the digital interface and display, in a display surface, an image expressed either by the analog RGB signal or by the digital signal, and the display apparatus comprising:
a first determination portion that makes a first determination of whether the analog RGB signal is present or absent;
a second determination portion that makes a second determination of whether the digital signal is present or absent;
a control portion that switches the switch to the analog RGB signal when the analog RGB signal has been determined to be present and that switches the switch to the digital signal when the digital signal has been determined to be present; and
a setting portion that starts a power-saving mode after a predetermined lapse of time when both the analog RGB signal and the digital signal have been determined to be absent.

8. The display apparatus according to claim 7,
wherein the digital signal is a DVI-D signal.

9. The display apparatus according to claim 8,
wherein the first determination and the second determination are carried out only when the display apparatus is initially turned on for use, and
a state of switching performed in accordance with the first determination and the second determination is stored in a memory, and the input is switched to match the state stored in the memory and an image is displayed the second and subsequent times the display apparatus is turned on.

10. The display apparatus according to claim 9,
wherein the second determination portion performs the second determination based on whether or not a predetermined voltage is being applied to a DDC terminal.

11. The display apparatus according to claim 10,
wherein the first determination portion determines that the analog RGB signal is present when both a horizontal synchronization signal and a vertical synchronization signal are being outputted.

12. The display apparatus according to claim 10,
wherein the first determination and the second determination are carried out at substantially the same time, by being carried out within a series of processes executed by a CPU.

13. A display apparatus provided with an analog interface for inputting an analog RGB signal and a digital interface for inputting a digital signal based on the DVI standard, the display apparatus being configured to switch, using a switch, to either the analog RGB signal inputted via the analog interface or the digital signal inputted via the digital interface and display, in a display surface, an image expressed either by the analog RGB signal or by the digital signal, and the display apparatus comprising:
a first determination portion that makes a first determination of whether the analog RGB signal is present or absent;
a second determination portion that makes a second determination of whether the digital signal is present or absent;
a control portion that switches the switch to the analog RGB signal when the analog RGB signal has been determined to be present and that switches the switch to the digital signal when the digital signal has been determined to be present,
the first determination and the second determination being carried out only when the display apparatus is initially turned on for use; and
a state of switching performed in accordance with the first determination and the second determination being stored in a memory, and the input being switched to match the state stored in the memory and an image is displayed the second and subsequent times the display apparatus is turned on.
